(19) United States
(12) Patent Application Publication
(10) Pub. No.: US 2006/0191299 A1
(43) Pub. Date: Aug. 31, 2006

(54) GARMENT STEAMER

(75) Inventors: Andrew J. Tobias, Pacific Palisades, CA (US); Robert Off, Escondido, CA (US)

Correspondence Address: KELLY LOWRY & KELLEY, LLP, 6320 CANOGA AVENUE, SUITE 1650, WOODLAND HILLS, CA, 91367, US

(73) Assignee: Andrew J. Tobias, Pacific Palisades, CA (US)

(21) Appl. No.: 11/164,871

(22) Filed: Dec. 8, 2005

Related U.S. Application Data
(60) Provisional application No. 60/636,677, filed on Dec. 15, 2004.

(51) Int. Cl. B08B 3/12; D06F 37/00

(52) U.S. Cl. 68/5 R; 68/5 B; 68/5 A

(57) ABSTRACT

A portable, modular garment steamer includes a carriage and steamer body detachably mounted thereon. The steam body includes a water tank, a reservoir and a steam chamber having a water heating element. A steam hose connected to the steam chamber permits a user to control the direction of steam exiting the steamer. The carriage includes wheels making the assembly movable. In addition the steamer body includes a carrying strap providing for portability when separated from the carriage. On/off switches as well as a thermostat and/or a timer permit the control and selective operation of a water heating element to control the generation of steam.

### BACKGROUND OF THE INVENTION

The invention relates generally to a device for treating fabric articles, including garments. More particularly, the present invention relates to a garment steamer.

There is a great need for portable, efficient devices to steam garments. It is well-known to use a steaming iron when ironing clothes and other garments. Non-iron devices called “steamers” have also been used to remove wrinkles and creases from clothes on a hanger or hanging from a rack by jetting steam to the clothes. These steamers do not have an ironing function because they lack the hot pressing plate found on irons. Both steam irons and steamers have been used for applying steam to remove creases and crinkles from hanging garments and other cloth materials. Steam has also been used in the cleaning of a variety of objects such as curtains, couches, furniture covers (e.g., couch covers), etc.

Many different types of irons and steam devices have been employed to iron and steam objects such as clothing. However, these steamers and steaming irons have their limitations, as described above and as follows. For example, U.S. Pat. No. 6,061,935 discloses an appliance for treating a garment with steamer and iron. However, this appliance is a relatively large, bulky, multi-part device that requires separate steamer and iron attachments that share a common water supply at a base to which the steamer and iron are attached. This system is not practical for situations that require portability.

While a device such as the one described above may provide means of steaming garments and the like, such a device can always be improved to provide better portability and flexibility.

Accordingly, there is a need for a garment steamer device that is portable and useful in a variety of applications. There is a further need for a garment steamer device that is modular. There is an additional need for a modular steamer device that is relatively compact in size and inexpensive. The present invention satisfies these needs and provides other related advantages.

Additional objects and advantages of the invention will be set forth in part in the drawings which follow, and in part will be obvious from the description, or may be learned by practice of the invention.

### SUMMARY OF THE INVENTION

The present invention resides in a portable, modular garment steamer having a carriage and a steamer body separable from the carriage. The steamer body is detachably mounted to the carriage to allow for increased portability of the steamer. The steamer body includes a water tank, a reservoir and a steam chamber. A steam hose is connected to the steam chamber.

The water tank includes a cap with a self-closing flow valve. The reservoir includes a platform configured for mated engagement with the flow valve such that the flow valve is opened when the water tank is inserted into the reservoir. A tube connects the reservoir to the steam chamber. A drain plug connected to the tube permits easy draining of the steamer.

The steam chamber includes a water heating element for converting the water into steam. The water heating element and a first on/off switch are electrically and operationally connected by a power cord or similar structure. In addition, a thermostat may be electrically and operationally connected to the first on/off switch. A timer may also be associated with the first on/off switch. A second on/off switch that is electrically and operationally connected to the heating element may be included. When the second on/off switch is included, the first on/off switch may be electrically and operationally connected only to the power cord.

The power cord may be modular and detachable from the steamer body or it may be permanently attached and retractable into a cavity in the steamer body. The steamer body may include a detachable carrying strap. The carriage may include a garment rod and bumper caps over respective wheels.

The accompanying drawings, which are incorporated in and constitute a part of this specification, illustrate several embodiments of the invention and together with the description, serve to explain the principles of the invention. It is to be understood that both the foregoing general description and the following drawings are exemplary and explanatory only and are not restrictive of the invention as to be claimed.

### BRIEF DESCRIPTION OF THE DRAWINGS

The accompanying drawings illustrate the invention. In such drawings:

FIG. 1 is an orthogonal view of a garment steamer embodying the present invention;

FIG. 2 is an orthogonal view of the garment steamer of FIG. 1 with the steamer removed from the truck;

FIG. 3 is a side elevational view of the garment steamer of FIG. 1;

FIG. 4 is a side elevational view of the garment steamer of FIG. 1 with the steamer removed from the truck;

FIG. 5 is a cross-sectional side elevational view of the garment steamer of FIG. 4;

FIG. 6 is a cross-sectional side elevational view of the garment steamer of FIG. 3;

FIG. 7 is a front elevational view of the steamer of FIG. 1;

FIG. 8 is a front elevational view of the carriage of FIG. 1;

FIG. 9 is a front elevational view of the garment steamer of FIG. 1;

FIG. 10 is a rear elevational view of the carriage of FIG. 1;

FIG. 11 is a rear elevational view of the steamer of FIG. 1;

FIG. 12 is a rear elevational view of the garment steamer of FIG. 1;

FIG. 13 is a partially exploded front elevational view of the carriage of FIG. 1;

FIG. 14 is a top plan view of the steamer of FIG. 1;

FIG. 15 is a bottom plan view of the steamer of FIG. 1;

FIG. 16 is a top plan view of the garment steamer of FIG. 1;

FIG. 17 is a top plan view of the carriage of FIG. 1; and

FIG. 18 is a bottom plan view of the carriage of FIG. 1.

### DETAILED DESCRIPTION OF THE INVENTION

The present invention is useful in a variety of applications that require flexibility, portability and modularity. This device is usable in any situation where an object needs to be steamed. These situations can occur anywhere there is a need to steam an object, such as in the home, in a hotel, at the office, or the like. The present invention is relatively compact in size and inexpensive.

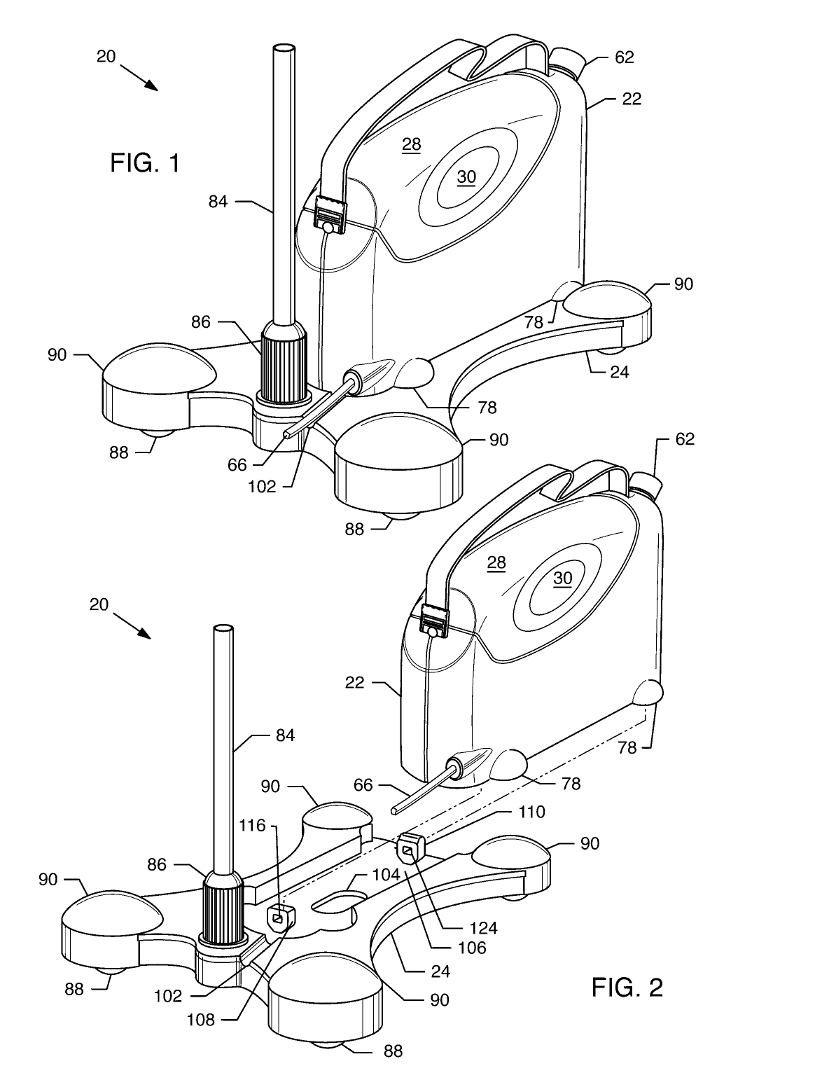

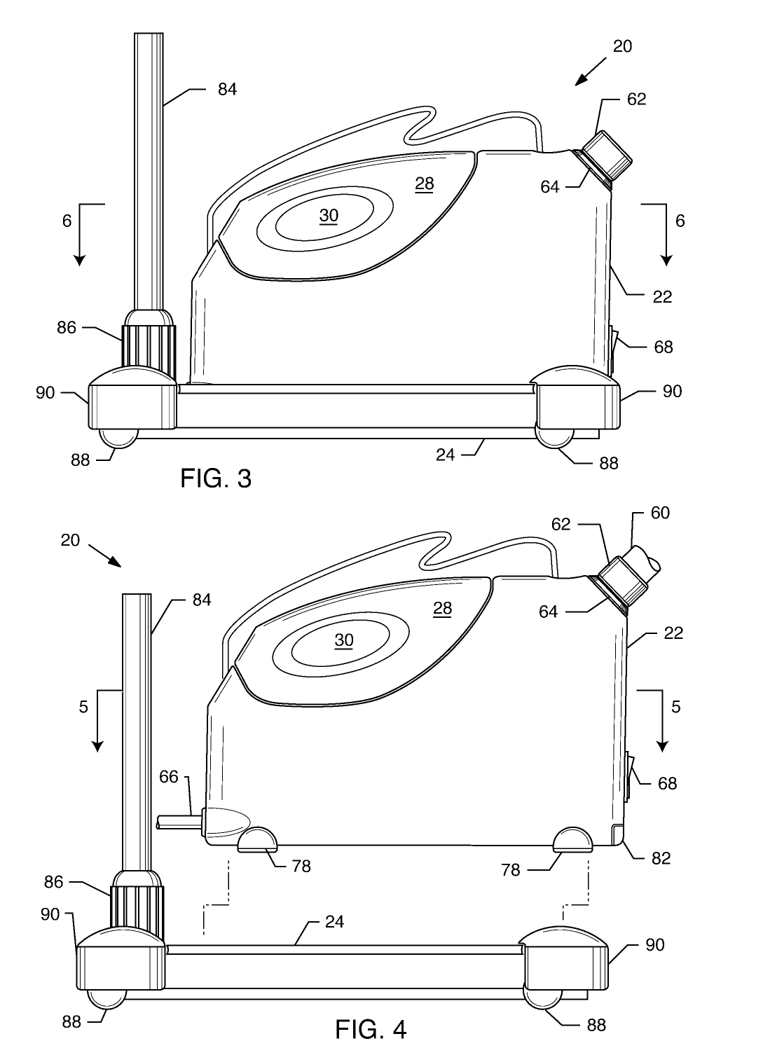

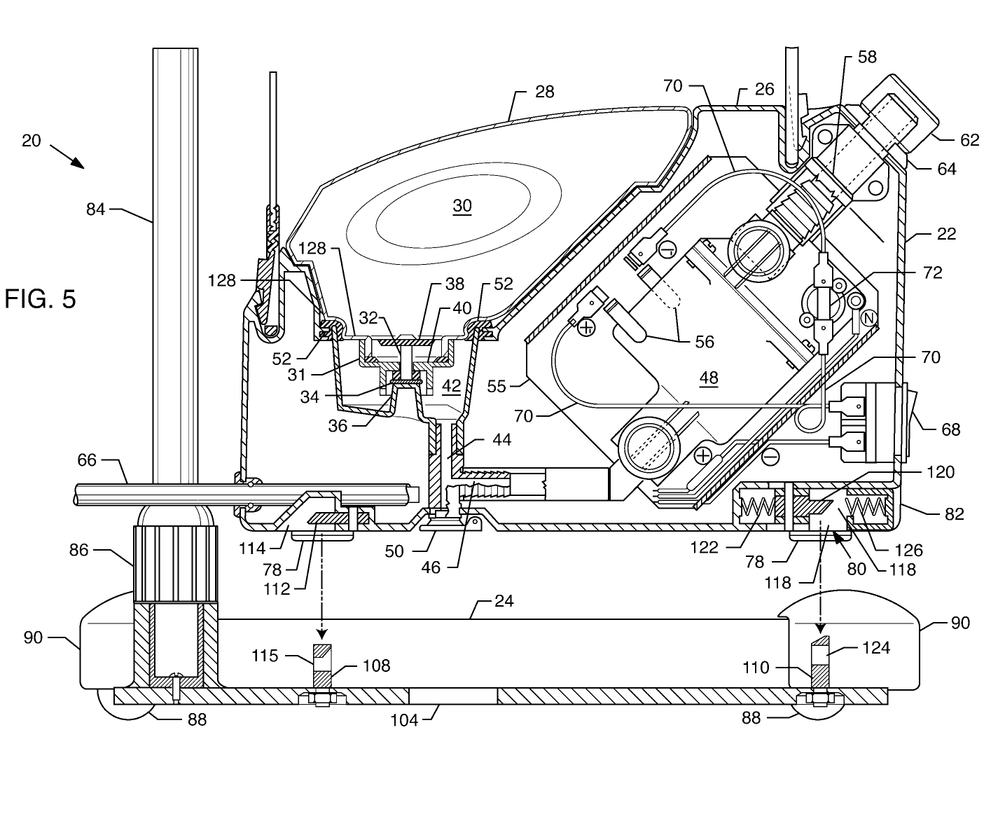

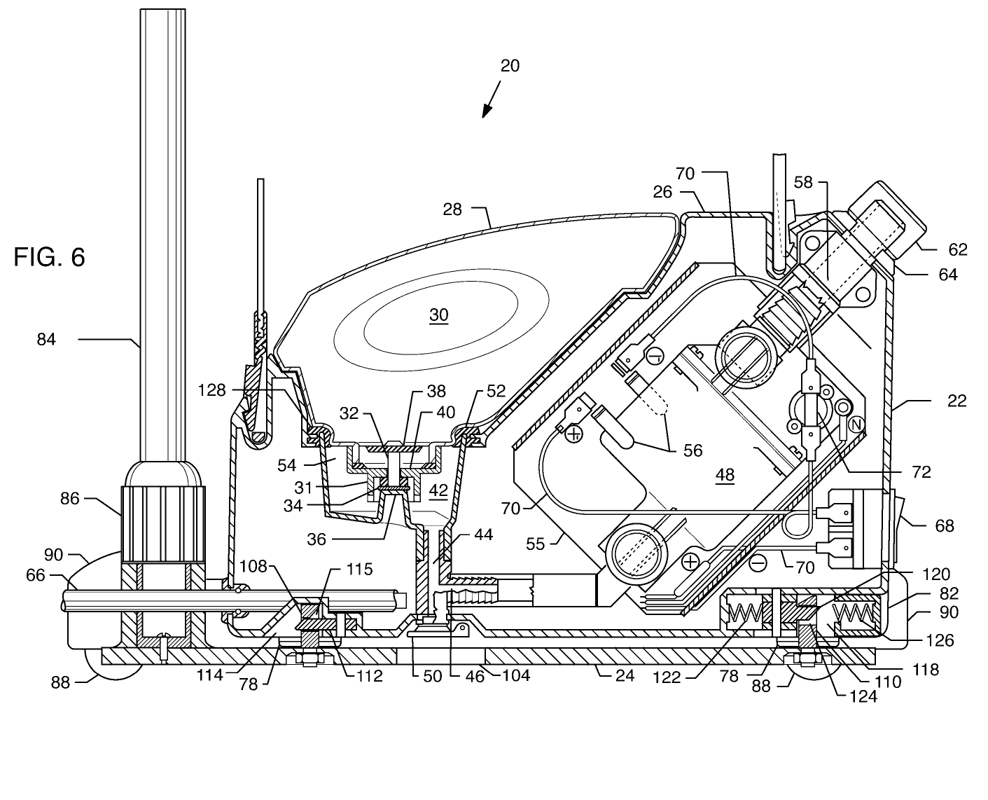

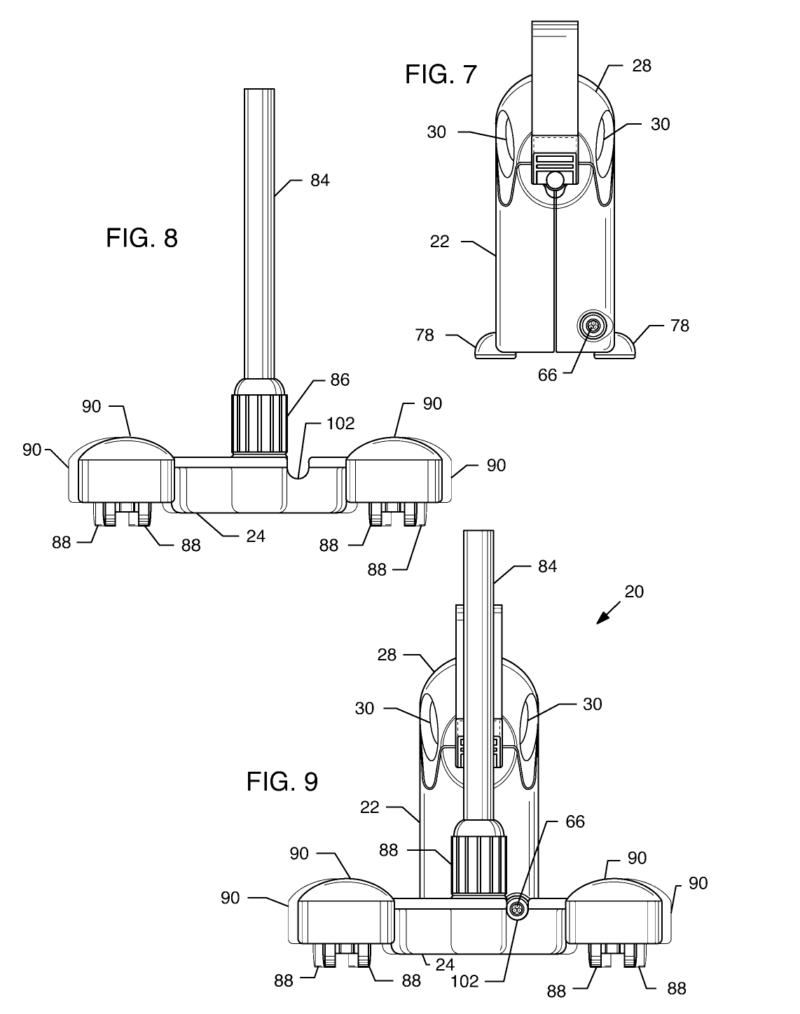

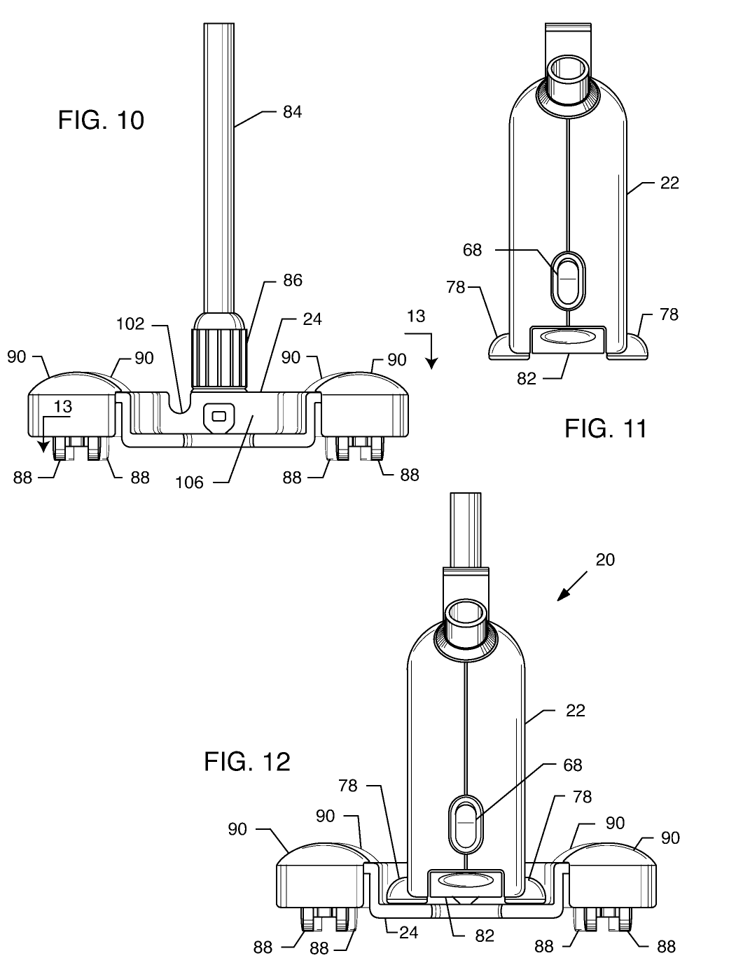

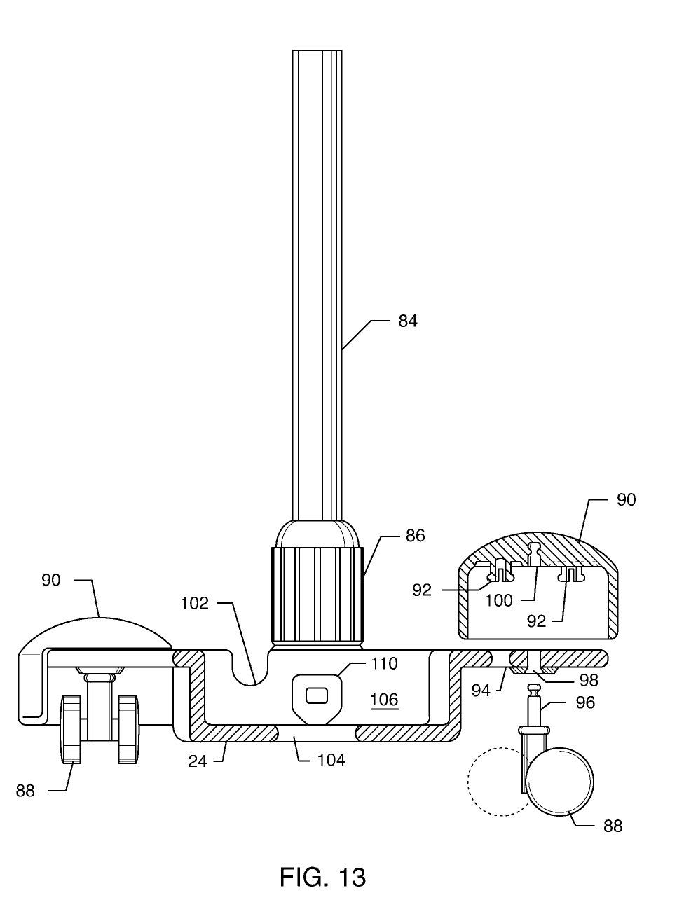

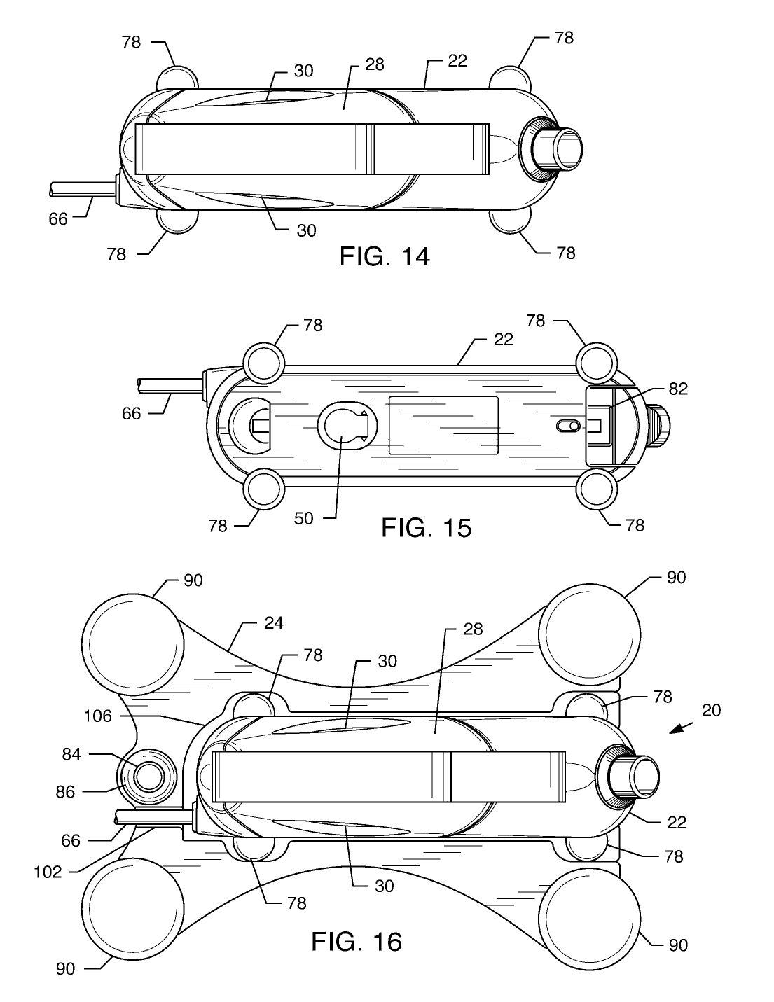

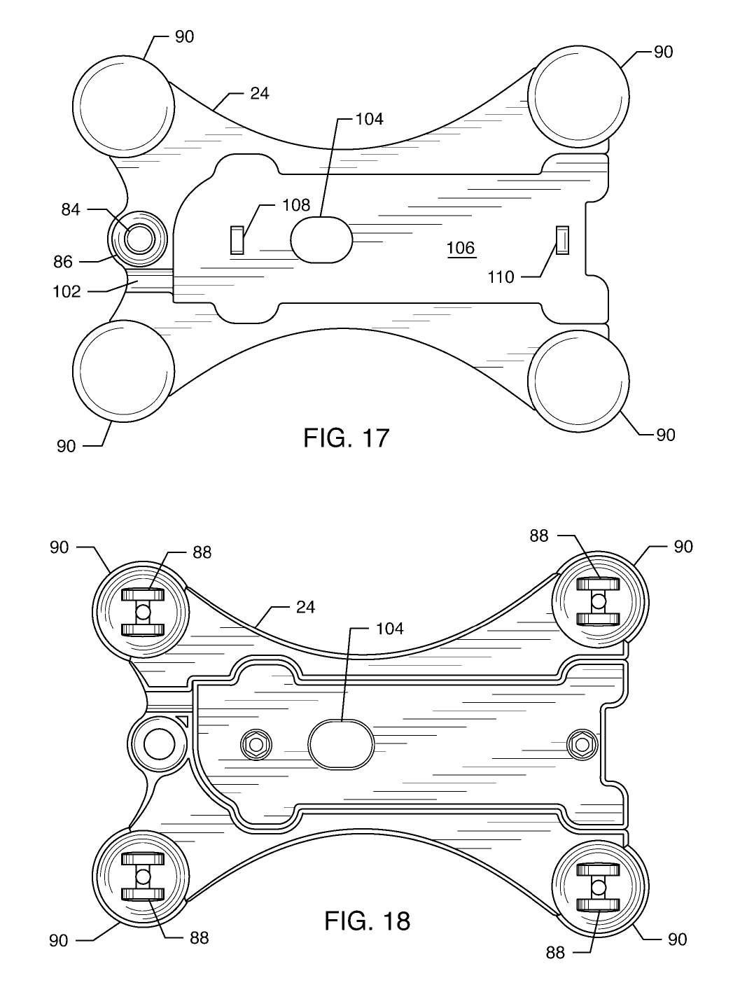

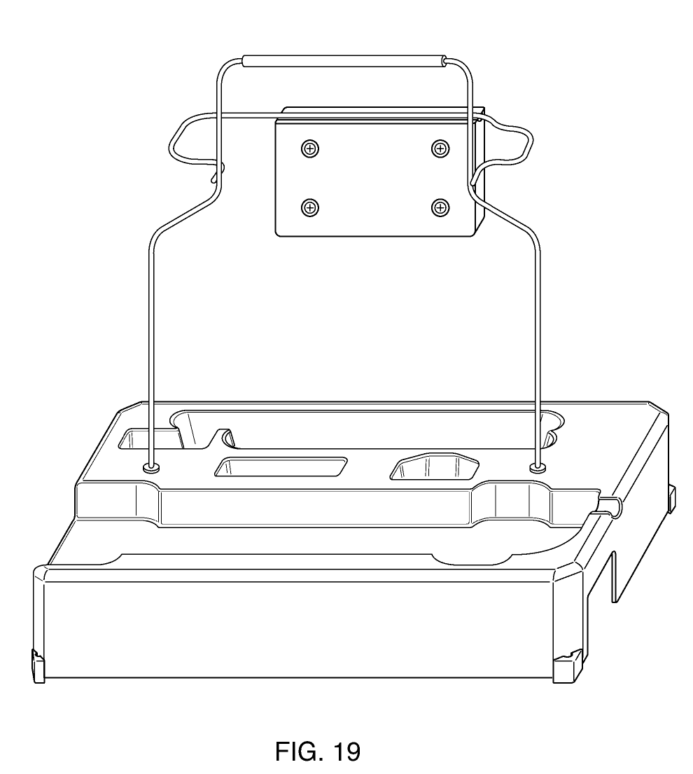

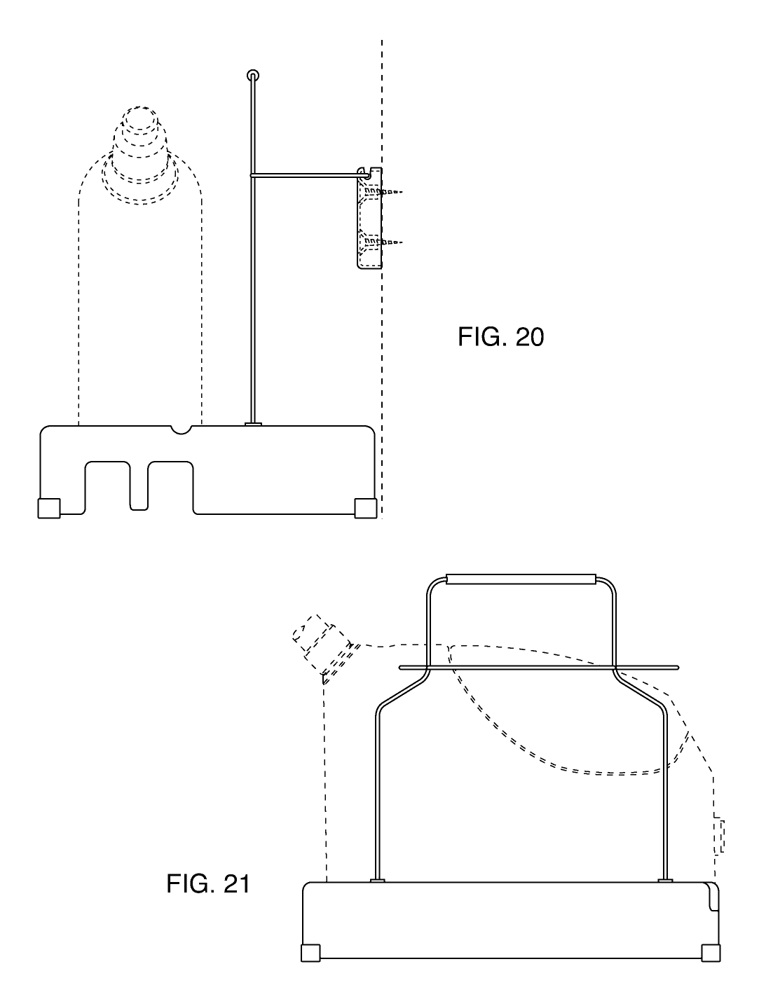

As shown in the drawings for purposes of illustration, the present invention resides in a garment steamer. With reference to FIGS. 1-18, a garment steamer device 20 includes a steamer 22 and a four-wheel truck carriage 24 upon which the steamer 22 rests. The garment steamer 22 can be placed upon the carriage 24 for portability or removed from the carriage 24 and shoulder-carried for convenience. In a first configuration, the steamer 22 is operably and detachably mounted only to the carriage 24 (FIGS. 1, 3, 6, 9, 12 and 16), and in a second configuration the steamer 22 is detached from the carriage 24 (FIGS. 2, 4, and 5).

The steamer 22 includes a housing 26 for electrical and mechanical parts. The steamer 22 includes a modular water tank 28 for holding a certain amount of water; the tank 28 holding the water that is to be converted into steam. The water tank 28 includes a grip indent 30 on both sides of the tank 28 for assisting a user in grasping the tank 26 for engagement with or removal from the housing 26 of the steamer 22. The water tank 28 is made from a semi-transparent or clear plastic so that the level of water within the tank 28 may be seen by a user. The housing 26 and tank 28 are shaped so as to present a continuous appearance when mated.

The tank 28 includes a cap 31 with a flow valve 32 designed so as to open when the tank 28 is mated to the housing 26 and close when the tank 28 is removed from the housing 26. When the tank 28 is aligned for mating to the housing 26, the valve 32 is facing downwards in a closed position. When the tank 28 is mated to the housing 28, one portion 34 of the valve 32 abuts against a platform 36 within the housing 26 that opens the valve 32 as the valve 32 comes into contact with the platform 36. When closed, another portion 38 of the valve 32 seals an aperture 40 of the tank 28.

The platform 36 is located in a reservoir 42 within the steamer 22. Water within the reservoir 42 drains downward along a tube 44 that leads to a lateral tube 46. The lateral tube 46 connects to a steam chamber 48 within the housing 26. The tube 44 also leads to a drain plug 50 located at the bottom of the steamer 22. The drain plug 50 is hinged so as to allow a user to open the drain plug 50 in order to drain the reservoir 42 and water from the water tank 28 when the tank 28 is mated to the housing 26.

A gasket 52 seals the top open aperture 54 of the reservoir 42 when the tank 28 is mated to the steamer 22, forming a press-fit seal.

The steam chamber 48 is surrounded by a heat shield 55 within the housing 26. The steam chamber 48 holds a certain amount of water and includes a heater 56 which heats the water in the chamber 48 in order to produce steam from the water. The heater 56 may be in the form of at least one metallic element which heats the water in the chamber 48 when electric current is applied to the metallic element. The metallic element may be made from any highly conductive metal, such as copper. The steam produced by the heater 56 is passed into a steam passage 58 within the steamer 22 and out of the steamer 22 through a steam hose 60. The steam hose 60 is connected to the steamer 22 by a hose lock-nut 62 and a lock nut cover 64. Various kinds of attachments for steaming garments may be connected at the free end of the hose 60.

The steamer 22 includes an expandable power cord 66 with a conventional plug (not shown) that plugs into a conventional wall electrical socket. Power from the power cord 66 supplies the power to the electrical system of the steamer 22 and the power cord 66 is electrically and operationally connected to an on/off switch 68 on the steamer 22 that regulates the flow of electrical power through the device 20. The on/off switch 68 is electrically and operationally connected through a plurality of electrical cables 70 to the heater 56. The on/off switch 68 is also electrically and operationally connected to a thermostat 72. The thermostat 72 automatically cuts power through the electrical system if the temperature within the steam chamber 48 gets too high. The on/off switch 68 also activates/deactivates emission of steam from the steamer 22. In the alternative, the power and steaming functions could be controlled by separate switches. One end of the power cord 66 is permanently attached to the steamer 22. In the alternative, the power cord 66 may be modular so as to be attachable/detachable to the steamer 22. In another alternative, the power cord 66 may be retractable and stored within a cavity (not shown) in the housing 26 when the steamer 22 is not in use. In the alternative, a timer may be associated with the on/off switch 68 to provide an automatic power shut-off.

The steamer 22 includes a carrying strap 74 with strap lock 76 for adjusting the length of the strap 74. The carrying strap 74 is attachable to and removable from the steamer 22. The steamer 22 further includes a plurality of rubber feet 78 on the bottom of the steamer 22 which allow the steamer 22 to rest upon a surface without the housing 26 touching the surface.

The steamer 22 also includes a truck carriage release mechanism 80 to disengage the steamer 22 from the carriage 24 when the steamer 22 and carriage 24 are mated. The release mechanism 80 includes a release button 82 located near the bottom rear of the steamer 22.

The carriage 24 includes an expandable garment rod 84 that is telescopically expandable between a recessed position and an expanded position. The garment rod 84 is set in a desired amount of extension by the user and then secured into position using a garment rod fastening device 86 located at the base of the garment rod 84. The fastening device 86 is turned in one direction to hold the rod 84 in a desired amount of expansion and turned in the opposite direction to loosen the hold on the rod 84 so that the rod 84 may be adjusted to a lesser or greater length.

The carriage 24 includes four wheels 88 or casters located at the corners of the carriage 24. A bumper cap 90 is located above and around each of the wheels 88 in order to protect furniture that the carriage 24 may pass near. The bumper cap 90 is designed with at least two press-fit mechanisms 92 designed to pass through matching apertures 94 in the carriage 24 so that the press-fit mechanisms 92 snap-in place and hold the bumper cap 90 in position. A shank 96 of each wheel 88 passes through an aperture 98 at a particular corner of the carriage 24. The shank 96 is designed so as to press-fit into a mating aperture 100 on the bumper cap 90.

The carriage 24 includes a channel 102 for the power cord 66 to pass along in order to prevent the cord 66 from getting tangled. The carriage 24 further includes an aperture 104 located under and aligned with the drain plug 50 of the steamer 22.

The carriage 24 includes a recess 106 located on a top surface of the carriage 24 that forms an outline of the steamer 22, shaped and sized so as to receive the steamer 22 when mated to the carriage 24. The carriage 24 further includes first and second posts 108, 118 for engaging the release mechanism 80 of the steamer 22 when is mated to the carriage 24.

The carriage 24 may be made of molded plastic or aluminum.

The steamer 22 engages the carriage 24 with a slide-in lock as the steamer 22 and carriage 24 may be operably and detachably mounted to each other. The steamer 22 and carriage 24 are slidingly engaged from a first direction at the posts 108, 110. A post 112 extending from a recess 114 within the bottom of the steamer 22 passes through a bore 115 in post 108. Concurrently, as the steamer 22 is lowered towards the recess 106 of the carriage 24, the post 110 passes into another recess 118 of the steamer 22 where the post 110 engages the release mechanism 80 of the steamer 22. The post 110 engages a post 120 extending into the recess 118. The post 120 is connected on one end to a spring 122 located within the steamer 22. As the post 120 of the steamer 22 engages the post 110 of the truck, pressure is exerted against the spring 122 which itself exerts pressure against the post 120 which, in turn, presses against the post 110 until the post 120 passes into a bore 124 within the post 110. The spring 122 ‘holds’ the post 120 in position until a user presses the release button 82. A spring 126 aligned with the post 120 is connected to the release button 82. When the release button 82 is pressed, the spring 126 contacts the post 120 and exerts sufficient pressure against the post 120 so as to push the post 120 sufficiently through the bore 124 of post 110 so as to allow the post 120 to be disengaged from the post 110 of the carriage 24. When both posts 112, 120 of the steamer 22 engage the posts 108, 110 of the carriage 24, the steamer 22 is mated to the carriage 24.

In use, a user may prepare a garment for wear by eliminating wrinkles and other creases from the garment by steaming the garment. The user, holding the tank 28 upside down, fills the tank 28 of the steamer 22 with water by pouring water through the aperture 40 of the tank 28. When the tank 28 is upside down, the flow valve 32 is open so that water can enter the tank 28. Once the tank 28 is filled to a desired level, the user then turns the tank 28 over which closes the valve 32. The user attaches the tank 28 to the steamer 22 by inserting the tank 28, cap 31 facing downward, into a recess 128 of the steamer 22 above the reservoir 42. The tank 28 press-fit seals against the gasket 52 that surrounds the top open aperture 54 of the reservoir 42 when the tank 28 is mated to the steamer 22. The platform 36 presses against the valve 32, opening the valve 32 and allowing water to flow into the reservoir 42 and into the steam chamber 48. The user may then connect the power cord 66 of the steamer 22 to an electrical source and activate the on/off switch 68 so that the water may be converted into steam.

The user then may adjust the height of the garment rod 84, place a garment upon the garment rod 84, and then proceed to steam the garment. In the alternative, the garment rod 84 may include an arm connected to the rod 84 and pivoted from alignment parallel to the rod 84 to approximately perpendicular to the rod 84 so that a user may drape a garment over the arm for steaming.

The above-described embodiments of the present invention are illustrative only and not limiting. It will thus be apparent to those skilled in the art that various changes and modifications may be made without departing from this invention in its broader aspects.

What is claimed is:

1. A portable, modular garment steamer, comprising:
a carriage;
a steamer body including a water tank, a reservoir and a steam chamber, wherein the steamer body is detachably mounted on the carriage; and
a steam hose connected to the steam chamber.

2. The garment steamer of claim 1, wherein the water tank includes a cap having a flow valve.

3. The garment steamer of claim 2, wherein the reservoir includes a platform for mated engagement with the flow valve.

4. The garment steamer of claim 1, including a tube for connecting the reservoir to the steam chamber and a drain plug connected to the tube.

5. The garment steamer of claim 1, wherein the steam chamber includes a water heating element.

6. The garment steamer of claim 5, further comprising means for electrically and operationally connecting the water heating element to a first on/off switch.

7. The garment steamer of claim 6, further comprising a thermostat electrically and operationally connected to the first on/off switch.

8. The garment steamer of claim 6, further comprising a second on/off switch, wherein the first on/off switch is electrically and operationally connected to the connecting means and the second on/off switch is electrically and operationally connected to the water heating element.

9. The garment steamer of claim 6, wherein the connecting means comprises a power cord which is modular and detachable from the steamer body.

10. The garment steamer of claim 6, wherein the connecting means comprises a power cord which is retractable into a cavity in the steamer body.

11. The garment steamer of claim 6, further comprising a timer associated with the first on/off switch.

12. The garment steamer of claim 1, wherein the carriage includes a garment rod and bumper caps over respective wheels.

13. The garment steamer of claim 1, wherein the steamer body includes a detachable carrying strap.

14. A portable, modular garment steamer, comprising:
a carriage;
a steamer body including a water tank, a reservoir and a steam chamber, wherein the steamer body is detachably mounted on the carriage;
the water tank including a cap having a flow valve;
a steam hose connected to the steam chamber; and
means for electrically and operationally connecting a water heating element in the water tank to a first on/off switch.

15. The garment steamer of claim 14, wherein the reservoir includes a platform for mated engagement with the flow valve.

16. The garment steamer of claim 14, including a tube for connecting the reservoir to the steam chamber and a drain plug connected to the tube.

17. The garment steamer of claim 14, further comprising a thermostat electrically and operationally connected to the first on/off switch.

18. The garment steamer of claim 14, further comprising a second on/off switch, wherein the first on/off switch is electrically and operationally connected to the connecting means and the second on/off switch is electrically and operationally connected to the water heating element.

19. The garment steamer of claim 14, wherein the connecting means comprises a power cord which is modular and detachable from the steamer body.

20. The garment steamer of claim 14, wherein the connecting means comprises a power cord which is retractable into a cavity in the steamer body.

21. The garment steamer of claim 14, further comprising a timer associated with the first on/off switch.

22. The garment steamer of claim 14, wherein the carriage includes a garment rod and bumper caps over respective wheels.

23. The garment steamer of claim 14, wherein the steamer body includes a detachable carrying strap.

24. A portable, modular garment steamer, comprising:
a carriage including a garment rod and bumper caps over respective wheels;
a steamer body including a water tank, a reservoir and a steam chamber, wherein the steamer body is detachably mounted on the carriage;
the water tank including a cap having a flow valve;
the reservoir including a platform for mated engagement with the flow valve;
a steam hose connected to the steam chamber; and
means for electrically and operationally connecting a water heating element in the water tank to a first on/off switch and a timer associated with the first on/off switch.

25. The garment steamer of claim 24, including a tube for connecting the reservoir to the steam chamber and a drain plug connected to the tube.

26. The garment steamer of claim 24, further comprising a thermostat electrically and operationally connected to the first on/off switch.

27. The garment steamer of claim 24, further comprising a second on/off switch, wherein the first on/off switch is electrically and operationally connected to the connecting means and the second on/off switch is electrically and operationally connected to the water heating element.

28. The garment steamer of claim 24, wherein the connecting means comprises a power cord which is modular and detachable from the steamer body.

29. The garment steamer of claim 24, wherein the connecting means comprises a power cord which is retractable into a cavity in the steamer body.

30. The garment steamer of claim 24, wherein the steamer body includes a detachable carrying strap.
